(19) United States
(12) Patent Application Publication
(10) Pub. No.: US 2005/0049341 A1
(43) Pub. Date: Mar. 3, 2005

(54) Foamable compositions which comprise isononyl benzoate

(75) Inventors: Michael Grass, Haltern am See (DE); Jurgen Koch, Haltern am See (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/912,132

(22) Filed: Aug. 6, 2004

(30) Foreign Application Priority Data
Aug. 7, 2003 (DE) 103 36 150.2

(51) Int. Cl. C08K 5/09

(52) U.S. Cl. 524/306; 524/315

(57) ABSTRACT

Compositions for producing foamed products which comprise a chlorinated polymer such as PVC and at least one isomeric nonyl benzoate as a plasticizer, the use of these compositions, and products produced therefrom including PVC-containing floorcoverings, synthetic leather, and wallcoverings.

### BACKGROUND OF THE INVENTION

1. Field of the Invention

The invention relates to foamable compositions which contain polyvinyl chloride and isononyl benzoate (INB), and to a process for preparing a foamed PVC product and products containing or derived from the foamable composition.

2. Description of the Related Art

Polyvinyl chloride (PVC) is an important commercial polymer. It is used in a wide variety of applications, including in the form of rigid PVC and in the form of plasticized PVC.

Plasticizers are added to PVC to produce a plasticized polymer. The plasticizer is in many cases a phthalic ester, in particular di-2-ethylhexyl phthalate (DEHP), diisononyl phthalate (DINP), or diisodecyl phthalate (DIDP). As the chain length of the ester increases, the solvation or gelling temperature of the plasticizer rises and the processing temperature of the plasticized PVC therefore also rises. The processing temperature can in turn be reduced by adding a fast-geller, such as a short-chain phthalate such as, for example, di-n-butyl phthalate (DBP), diisobutyl phthalate (DIEP), benzyl butyl phthalate (BBP), or diisoheptyl phthalate (DIHP). Dibenzoic esters, such as dipropylene glycol dibenzoate or the like may be added for the same purpose.

A marked rise in viscosity over time is a property frequently exhibited by these fast-geller plasticizers in PVC plastisols due to their high solvating power. In many cases the viscosity rise has to be compensated for by adding (often expensive) viscosity-reducers.

When PVC plastisols are prepared, the general requirement is low viscosity and minimum gelling temperature. In addition, high storage stability (e.g., a low rise in viscosity of the plastisol over time) is desirable.

High viscosity may be disadvantageous during processing of the plastisol on machinery (such as spreading or dipping). Excessively high gelling temperature may lead to discolorations due to thermal stress.

Currently there are few plasticizers which significantly lower the gelling temperature in a plastisol formulation while retaining a low level of viscosity especially after storage for a number of days. 2-Ethylhexyl benzoate was recently proposed as a product which could fulfill these requirements [Bohnert, Stanhope, J. Vinyl Addit. Technol. (2000), 6(3), 146-149]. However, this compound has a comparatively high vapor pressure, which often leads to unacceptable losses of the plasticizer during processing, and to comparatively high emissions during use.

WO 01/29140 discloses the use of benzoic esters of C₈ alcohols in film-forming compositions.

U.S. Pat. No. 5,236,987 describes the use of benzoates derived from C₈-C₁₂ alcohols in plastisols. The use of these compounds by way of example in latex formulations is also described.

DE 19 62 500 discloses compositions which comprise a vinyl polymer and one or more esters of benzoic acid with a C₈-C₁₃ alcohol, and also, where appropriate, succinic esters. These compositions are used to produce polymer films.

WO 97/39060 describes plastisols which comprise, as plasticizer, a benzoate of a C₁₁-C₁₄ alcohol. These plasticizers are used inter alia in plastisols to produce foams, but no improvement of foam structure was found when comparison was made with conventional plastisols. Nor was any significant decrease of gelling temperature found in blends with DINP.

### SUMMARY OF THE INVENTION

Accordingly, it is an object of the present invention to provide compositions for forming foamed layers which comprise homo- or copolymers of vinyl chloride and/or of polyvinylidene dichloride, and/or of chlorinated polyethylene, and an alkyl benzoate which significantly lower both the viscosity and the gelling temperature of the composition, generally a plastisol, and thus permit easier and faster processing. In addition, the alkyl benzoate may be derived from minimum-cost raw materials.

Surprisingly, it has been found that foamable compositions which comprise at least one polymer selected from polyvinyl chloride, polyvinylidene chloride, chlorinated polyolefins, and copolymers of vinyl chloride with vinylidene chloride, vinyl acetate, vinyl propionate, vinyl butyrate, vinyl benzoate, methyl acrylate, ethyl acrylate, butyl acrylate, and which comprise at least one primary plasticizer, and an isononyl benzoate are capable of easy and rapid processing.

In one embodiment, the present invention provides foamable compositions for producing foamed products, comprising at least one polymer selected from polyvinyl chloride, polyvinylidene chloride, chlorinated polyolefins, and copolymers of vinyl chloride with vinylidene chloride, vinyl acetate, vinyl propionate, vinyl butyrate, vinyl benzoate, methyl acrylate, ethyl acrylate, and butyl acrylate, and at least one primary plasticizer, and an alkyl benzoate and, where appropriate, other additives, wherein isononyl benzoate is present as alkyl benzoates in the composition. The amount of all of the plasticizers present is from 10 to 400 parts by weight, based on 100 parts by weight of polymers and the proportion of the isononyl benzoate is from 5 to 95% by weight of the total amount of the plasticizers.

The present invention also provides the use of compositions of the invention for producing foamed products where the foamed products comprise at least one polymer selected from polyvinyl chloride, polyvinylidene chloride, chlorinated polyolefins, and copolymers of vinyl chloride with vinylidene chloride, vinyl acetate, vinyl propionate, vinyl butyrate, vinyl benzoate, methyl acrylate, ethyl acrylate, and butyl acrylate, and further comprise at least one primary plasticizer, an isononyl benzoate, and, where appropriate, other additives.

The invention also provides a process for producing products which have at least one foamed polymer layer selected from the following polymers: polyvinyl chloride, polyvinylidene chloride, chlorinated polyolefins and copolymers of vinyl chloride with vinylidene chloride, vinyl acetate, vinyl propionate, vinyl butyrate, vinyl benzoate, methyl acrylate, ethyl acrylate, and butyl acrylate, which includes applying a composition according to the invention to a backing or a further polymeric layer and foaming the composition prior to or after application and finally using heat to process the applied and foamed layer. The present invention also provides products which comprise at least one polymer selected from polyvinyl chloride, polyvinylidene chloride, chlorinated polyolefins and copolymers of vinyl chloride with vinylidene chloride, vinyl acetate, vinyl propionate, vinyl butyrate, vinyl benzoate, methyl acrylate, ethyl acrylate, and butyl acrylate.

An advantage of the composition of the invention is that the marked rises in viscosity at relatively high shear rates (known as dilatancy) found when processing prior-art compositions (e.g. blends of glycol dibenzoates) are avoided, or are found only to a markedly lower extent, during the processing of compositions of the invention, either for the production of chemical foams or else for the production of mechanical foams.

The compositions of the invention not only have low viscosity, even after prolonged storage, but also gel more rapidly and have good low-temperature flexibility. In comparison with conventional foamable compositions which may comprise, for example, benzyl butyl phthalate, diisobutyl phthalate, or glycol dibenzoates as plasticizers, foamability is also found to be better (e.g., lower foam densities).

### DETAILED DESCRIPTION OF THE INVENTION

Some of the compositions of the invention and the processes of the invention are described below by way of example. There is no intention that the invention be restricted to these embodiments.

In the foamable compositions of the invention comprising at least one polymer selected from polyvinyl chloride, polyvinylidene chloride, chlorinated polyolefins, and copolymers of vinyl chloride with vinylidene chloride, vinyl acetate, vinyl propionate, vinyl butyrate, vinyl benzoate, methyl acrylate, ethyl acrylate, and butyl acrylate, at least one primary plasticizer is present, and where appropriate, the composition may comprise other additives. The compositions comprise isononyl benzoate and the amount of all of the plasticizers present is from 10 to 400 parts by weight, based on 100 parts by weight of polymers. The proportion of the isononyl benzoate is from 5 to 95% by weight of the total amount of the plasticizers. It can be advantageous for the proportion of a mixture of one or more primary plasticizers and isononyl benzoate to be present in the composition in an amount of from 15 to 200 parts by weight, preferably from 20 to 100 parts by weight, based on 100 parts by weight of polymer. It can also be advantageous for the plasticizer mixture itself to comprise from 10 to 70% by weight, preferably from 10 to 50% by weight, of isononyl benzoate.

The composition of the invention preferably comprises an isomeric mixture of isononyl benzoates, derived from nonyl alcohols obtained by saponifying the isomeric isononyl benzoates. The mixture of isononyl benzoates is preferably derived from a mixture of alcohols comprising less than 10 mol % of 3,5,5-trimethylhexanol. The method for saponifying the benzoic esters and, respectively, the other esters mentioned below, may be one of the usual methods such as reaction with alkaline media (see by way of example Ullmann's Enzyklopädie der Technischen Chemie [Ullmann's Encyclopedia of Industrial Chemistry], 5th edn. A 10, pp. 254-260 incorporated herein by reference).

Examples of the foamable compositions of the invention include plastisols. Among the abovementioned polymers, preference is given to those which permit the preparation of plastisols. A composition of the invention particularly preferably comprises one or more grades of PVC which have been prepared by the emulsion polymerization process, (e.g., emulsion PVC or E-PVC). A composition of the invention very particularly preferably comprises E-PVC whose molecular weight, stated as K value (Fikentscher constant) is from 60 to 90, and particularly preferably from 65 to 85.

As primary plasticizers, the compositions of the invention may comprise one or more of the compounds listed below, e.g. dialkyl phthalates, having an alkyl radical containing from 4 to 13 carbon atoms, alkyl adipates having an alkyl radicals containing from 4 to 13 carbon atoms, and/or alkyl cyclohexanedicarboxylates having an alkyl radical containing from 4 to 13 carbon atoms, trimellitic esters having from 7 to 10 carbon atoms in the alcohol chain, alkylsulfonic esters derived from phenol, polymeric plasticizers, alkyl benzyl phthalates, e.g. butyl benzyl phthalates or octyl benzyl phthalates, dibenzoic esters of in particular, diethylene glycol, dipropylene glycol or triethylene glycol, and/or citric esters.

Among this list of the preferred primary plasticizers, particular preference is given to those listed below.

Among the dialkyl phthalates, particular preference is given to those whose alkyl radicals have from 4 to 11 carbon atoms. It is unimportant here whether the alkyl radicals are identical or different and/or linear or branched. Dialkyl phthalates particularly preferred here are diisobutyl phthalate (DIBP), di-n-butyl phthalate (DBP), benzyl n-butyl phthalate (BBP), diisopentyl phthalate (DIPP), diisoheptyl phthalate (DIHP), di-2-ethylhexyl phthalate (DEHP), diisooctyl phthalate (DIOP), diisononyl phthalate (DINP), diisodecyl phthalate (DIDP), di-2-propylheptyl phthalate (DPHP), diisoundecyl phthalate (DIUP), di-C₈-C₁₀-alkyl phthalate, di-C₇-C₉-alkyl phthalate, di-C₇-C₁-alkyl phthalate, di-C₉-C₁₁-alkyl phthalate, and/or di-C₆-C₁₀-alkyl phthalate.

Among the cyclohexanedicarboxylic esters, preference is given to those whose alkyl radicals have from 7 to 11 carbon atoms. It is likewise unimportant here whether the alkyl radical are identical or different and/or linear or branched, or what cis-trans ratio pertains between the ester groups. Particularly preferred cyclohexanedicarboxylic esters are diisoheptyl 1,2-cyclohexanedicarboxylate, di-2-ethylhexyl 1,2-cyclohexanedicarboxylate, diisononyl 1,2-cyclohexanedicarboxylate, diisodecyl 1,2-cyclohexanedicarboxylate, di-2-propylheptyl 1,2-cyclohexanedicarboxylate, diisoheptyl 1,4-cyclohexanedicarboxylate, di-2-ethylhexyl 1,4-cyclohexanedicarboxylate, diisononyl 1,4-cyclohexanedicarboxylate, diisodecyl 1,4-cyclohexanedicarboxylate, and/or di-2-propylheptyl 1,4-cyclohexanedicarboxylate.

In the case of the trimellitic esters (e.g., 1,2,4-benzenetricarboxylic esters) having from 7 to 10 carbon atoms in the alcohol chain, it is again unimportant whether the alkyl radicals are identical or different and/or linear or branched. Particularly preferred trimellitic esters are tri-2-ethylhexyl trimellitate, triisononyl trimellitate, triisodecyl trimellitate, tri-2-propylheptyl trimellitate, tri-C₇-C₉-alkyl esters and/or, tri-C₈-C₁₀-alkyl esters.

Citric esters present in the compositions of the invention may preferably include those having from 2 to 10 carbon atoms in the alcohol chains, in each case with or without a carboxylated OH group. It is unimportant whether the alkyl radicals are identical or different, linear or branched. Particular preference is given to tributyl acetylcitrate, tri-2-ethylhexyl citrate, tri-2-ethylhexyl acetylcitrate, triisononyl acetylcitrate, triisononyl citrate, tri-n-butyl citrate, tri-C₆-C₁₀-alkyl citrate, tri-n-hexyl butyrylcitrate as citric esters in the composition of the invention.

In the case of adipic esters having from 4 to 13 carbon atoms in the alcohol chain it is again unimportant whether the alkyl radicals are identical or different and/or linear or branched. Dibutyl adipate, di-2-ethylhexyl adipate, diisononyl adipate, diisodecyl adipate, di-2-propylheptyl adipate, diisotridecyl adipate are particularly preferably present as adipic esters in the composition of the invention.

As dibenzoic esters, the composition of the invention preferably comprises alkylenediol dibenzoates, and, in particular, glycol dibenzoates, such as diethylene glycol dibenzoate, dipropylene glycol dibenzoate, diisopropylene glycol dibenzoate, dibutylene glycol dibenzoate, tripropylene glycol dibenzoate, triethylene glycol dibenzoate, or a mixture composed of two or more of these compounds.

A composition of the invention particularly preferably comprises, as primary plasticizer, an alkyl phthalate, with preference diisononyl phthalate (DINP), diisoheptyl phthalate (DIHP), diisodecyl phthalate (DIDP), di-2-propylheptyl phthalate (DPHP) and/or di-2-ethylhexyl phthalate (DEHP), an alkyl cyclohexanedicarboxylate, preferably diisononyl cyclohexanedicarboxylate (DINCH), and/or an alkyl adipate, preferably diisononyl adipate (DINA), and/or di-2-ethylhexyl adipate (DEHA).

Clearly, the compounds mentioned and present as primary plasticizers in the composition may include commercially available products. For example, the compositions of the invention may comprise, as benzoates, the commercial products K-flex (Kalama Chem; by way of example the product grades DP, DE and 500) or Benzoflex (Velsicol; by way of example the product grades 9-88, 2-45, 50, 2088), which can be prepared from the raw materials benzoic acid, diethylene glycol, dipropylene glycol, and triethylene glycol. Phthalates which may be used in the compositions of the invention are the industrial phthalates obtainable by way of example with the tradenames Vestinol C (di-n-butyl phthalate) (CAS No.84-74-2), Vestinol IB (di-1-butyl phthalate) (CAS No. 84-69-5), Jayflex DINP (CAS No.68515-48-0), Jayflex DIDP (CAS No.68515-49-1), Palatinol 9P (68515-45-7), Vestinol 9 (CAS No. 28553-12-0), TOTM (CAS No. 3319-31-1), Linplast 68-TM, Palatinol N (CAS No. 28553-12-0), Jayflex DHP (CAS No. 68515-50-4), Jayflex DIOP (CAS No. 27554-26-3), Jayflex UDP (CAS No. 68515-47-9), Jayflex DIUP (CAS No. 85507-79-5), Jayflex DTDP (CAS No.68515-47-9), Jayflex L9P (CAS No. 68515-45-7), Jayflex L911P (CAS No. 68515-43-5), Jayflex L11P (CAS No. 3648-20-2), Witamol 110 (CAS No. 68515-51-5), Witamol 118 (di-n-C₈-C₁₀-alkyl phthalate) (CAS No.71662-46-9), Unimoll BB (CAS No. 85-68-7), Linplast 1012 BP (CAS No. 90193-92-3), Linplast 13XP (CAS No.27253-26-5), Linplast 610P (CAS No. 68515-51-5), Linplast 68 FP (CAS No. 68648-93-1), Linplast 812 HP (CAS No. 70693-30-0), Palatinol AH (CAS No. 117-81-7), Palatinol 711 (CAS No. 68515-42-4), Palatinol 911 (CAS No. 68515-43-5), Palatinol 11 (CAS No. 3648-20-2), Palatinol Z (CAS No.26761-40-0), Palatinol DIPP (CAS No. 84777-06-0), Jayflex 77 (CAS No. 71888-89-6), Palatinol 10 P (CAS No. 53306-54-0) or Vestinol AH (CAS No. 117-81-7). “CAS No.” means Chemical Abstracts Registry Number. It is, of course, also possible to use mixtures of two or more of these commercially available products as primary plasticizers in the composition of the invention.

Besides the compounds mentioned immediately above, which may be present as primary plasticizers in the composition of the invention, it is also possible for polymeric plasticizers based on dicarboxylic acids, such as adipic or phthalic acid, and on polyhydric alcohols to be present as primary plasticizers in the composition of the invention.

The foamable composition of the invention may comprise, as additives, for example, at least one selected from the group of filler, pigment, heat stabilizer, antioxidant, viscosity regulator, foam stabilizer, and/or lubricant.

One of the functions of the heat stabilizers is to neutralize hydrochloric acid eliminated during and/or after the processing of the PVC, and to inhibit thermal degradation of the polymer. The heat stabilizers may be any conventional PVC stabilizers in solid or liquid form, for example those based on Ca/Zn, on Ba/Zn, on Pb, on Sn, or on organic compounds (OBSs), and also acid-binding phyllosilicates, such as hydrotalcite. The mixtures of the invention may have from 0.5 to 10 parts by weight, preferably from 1 to 5 parts by weight, particularly preferably from 1.5 to 4 parts by weight of the heat stabilizer per 100 parts by weight of polymer.

For the purposes of the present invention, pigments which may be used comprise not only inorganic but also organic pigments. The content of pigments is from 0.01 to 10% by weight, preferably from 0.05 to 5% by weight, particularly preferably from 0.1 to 3% by weight. Examples of inorganic pigments are CdS, CoO/Al₂O₃, Cr₂O₃. Known organic pigments by way of example are azo colorants, phthalocyanine pigments, dioxazine pigments, and aniline pigments.

Viscosity-lowering reagents which may be used comprise aliphatic or aromatic hydrocarbons, but also carboxylic acid derivatives, e.g. 2,2,4-trimethyl-1,3-pentadiol diisobutyrate, known as TXIB (Eastman). The latter may also readily be replaced by isononyl benzoate, because intrinsic viscosity is similar. The proportions of viscosity-lowering reagents added are from 0.5 to 50 parts by weight, preferably from 1 to 30 parts by weight, particularly preferably from 2 to 10 parts by weight, per 100 parts by weight of polymer.

Foam stabilizers which may be present in the composition of the invention may include commercially available foam stabilizers. By way of example, these foam stabilizers may include silicone-based or soap-based stabilizers, and such as tradenames BYK (Byk-Chemie) and SYNTHAMID (Th. Boehme GmbH), for example. The amounts of these present in an invention composition may be from 1 to 10 parts by weight, preferably from 1 to 8 parts by weight, particularly preferably from 2 to 4 parts by weight, per 100 parts by weight of polymer.

Depending on whether the foamable composition is intended to be foamed chemically or mechanically, the composition may further comprise one or more components which generate gas, in the form of, for example, bubbles and may optionally comprise a kicker defined below. The foamable component preferably comprises a compound which decomposes on exposure to heat to give predominantly gaseous constituents which bring about expansion of the composition. One typical representative of these compounds, by way of example, is azodicarbonamide. The decomposition temperature of the blowing agent may be reduced markedly in the presence of catalysts in the composition of the invention. These catalysts are known as “kickers” to the person skilled in the art, and may be added either separately or preferably in the form of a single system with the stabilizer.

The preparation of the isononyl benzoate present in the composition of the invention is described below. The product that may be used for preparing the isononyl benzoate is a mixture of isomeric nonyl alcohols and benzoic acid. The mixture of isomeric nonyl alcohols used to prepare the isononyl benzoate is often termed isononanol. The mixtures (e.g. isononanols) preferably have high linearity characterized by a proportion of less than 10 mol % (from 0 to 10), preferably less than 5 (from 0 to 5) mol %, particularly preferably less than 2 (from 0 to 2) mol %, of 3,5,5-trimethylhexanol. The isomeric distribution of nonyl alcohol mixtures is determined by the manner of preparation of the nonyl alcohol (isononanol). The isomeric distributions of the nonyl radicals may be determined using conventional measurement methods familiar to the person skilled in the art, e.g. NMR spectroscopy, or GC or GC/mass spectroscopy. These properties made here relate to all of the nonyl alcohol mixtures mentioned below. These nonyl alcohols (e.g., nonyl alcohol mixtures) include commercially available mixtures with CAS numbers 27458-94-2, 68515-81-1, 68527-05-9 or 68526-84-1.

Isononanol may be prepared by hydroformylating octenes, which in turn are produced in various ways. Industrial C₄ streams may be used as the raw material for this purpose and initially comprise all of the isomeric C₄ olefins alongside the saturated butanes and sometimes contamination, such as C₃ and C₅ olefins and acetylenic compounds. Oligomerization of this olefin mixture predominantly gives isomeric octene mixtures alongside higher oligomers, such as C₁₂ and C₁₆ olefin mixtures. These octene mixtures are hydroformylated to give the corresponding aldehydes, and then hydrogenated to give the alcohol.

The constitution, i.e. the isomeric distribution, of the industrial nonanol mixtures depends on the starting material and on the oligomerization and hydroformylation processes. Any of these mixtures may be used to prepare the esters of the invention. Preferred nonanol mixtures are those which have been obtained by hydroformylating C₈ olefin mixtures obtained by oligomerizing substantially linear butenes on nickel support catalysts (e.g. OCTOL process, OXENO Olefinchemie GmbH), in the presence of known catalysts, e.g. Co compounds or Rh compounds, and then hydrogenating the hydroformylation mixture after catalyst removal. The proportion of isobutene in the starting material, based on the total butene content, is less than 5% by weight, preferably less than 3% by weight, particularly preferably less than 1% by weight. As a result of this, the proportion of relatively highly branched nonanol isomers, including that of 3,5,5-trimethylhexanol, which has not proven to be particularly advantageous, is markedly suppressed and is within the preferred ranges.

The composition of the invention may also comprise isononyl benzoates which are obtained by esterifying benzoic acid with a commercially available alcohol mixture which may by way of example have the CAS numbers 68551-09-7, 91994-92-2, 68526-83-0, 66455-17-2, 68551-08-6, 85631-14-7 or 97552-90-4. These are alcohol mixtures which comprise not only the isononyl alcohols mentioned but also alcohols having from 7 to 15 carbon atoms (in accordance with CAS definition). The result is therefore alkyl benzoate mixtures which comprise not only isononyl benzoate but also other alkyl esters of benzoic acid.

The preparation of isononyl benzoate, i.e. the esterification of benzoic acid with an isomerically pure nonanol or with an isononanol mixture to give the corresponding esters, may be carried out autocatalytically or catalytically, for example using Brönstedt or Lewis acids. Quite irrespective of the type of catalysis selected, the result is always a temperature-dependent equilibrium between the starting materials (acid and alcohol) and the products (ester and water). In order to shift the equilibrium in favor of the ester, use may be made of an entrainer, which allows removal of the water produced by the reaction. Since the alcohol mixtures used for esterification have lower boiling points than the benzoic acid and its esters and have a region of immiscibility with water, they are often used as entrainer which can be returned to the process after removal of water.

The alcohol or, respectively, the isomeric alcohol mixture used to form the ester and simultaneously act as entrainer is used in excess, this preferably being from 5 to 50%, in particular from 10 to 30%, in addition to the amount needed to form the ester.

Esterification catalysts which may be used are acids, such as sulfuric acid, methane sulfonic acid, or p-toluenesulfonic acid, or metals, or their compounds. Examples of those suitable are tin, titanium, and zirconium, and these may be used in the form of finely divided metals, or advantageously in the form of their salts, oxides, or soluble organic compounds. Unlike protonic acids, the metal catalysts are high-temperature catalysts whose full activity is often not achieved until temperatures reach above 180° C. However, their use is preferred since the level of formation of by-products, such as olefins from the alcohol used, is lower when comparison is made with protonic catalysis. Examples representing metal catalysts are tin powder, stannous oxide, stannous oxalate, titanium esters, such as tetraisopropyl orthotitanate or tetrabutyl orthotitanate, and zirconium esters, such as tetrabutyl zirconate.

The concentration of catalyst depends on the nature of the catalyst. In the case of the titanium compounds whose use is preferred, it is from 0.005 to 1.0% by weight, based on the reaction mixture, in particular from 0.01 to 0.5% by weight, very particularly from 0.01 to 0.1% by weight.

When titanium catalysts are used, the reaction temperatures are from 160 to 270° C., preferably from 180 to 250° C. The ideal temperatures depend on the starting materials, the progress of the reaction, and the concentration of catalyst. They may readily be determined by trials for each individual case. Higher temperatures increase the reaction rates and favor side reactions, such as elimination of water from alcohols or formation of colored by-products. For removal of the water of reaction, it is advantageous that the alcohol can be distilled off from the reaction mixture. The desired temperature or the desired temperature range may be set via the pressure in the reaction vessel. For this reason, the reaction is carried out at superatmospheric pressure in the case of low-boiling alcohols, and at subatmospheric pressure in the case of relatively high-boiling alcohols. For example, operations for the reaction of benzoic acid with a mixture of isomeric nonanols are carried out in a range of temperature from 170 to 250° C. in the range of pressures from 1 bar to 10 mbar.

Some or all of the liquid to be returned to the reaction may be composed of alcohol obtained by work-up of the azeotropic distillate. It is also possible to carry out the work-up at a later juncture, and to replace some or all of the amount of liquid removed by fresh alcohol, i.e. alcohol provided in a feed vessel.

The crude ester mixtures, which comprise by-products as well as the ester(s), alcohol, and catalyst or products derived from the catalyst, are worked up by processes known per se. This work-up encompasses the following steps: removal of the excess alcohol and, where appropriate, low-boilers, neutralization of the acids present, and optional steam distillation, conversion of the catalyst into a residue which is easy to filter, removal of the solids, and, where appropriate, drying. The sequence of these steps may differ, depending on the work-up process used.

The nonyl ester or the mixture of the nonyl esters may be removed from the reaction mixture by distillation, where appropriate after neutralization of the mixture.

As an alternative, the nonyl benzoates of the invention may be obtained by transesterifying a benzoic ester with nonanol or with an isononanol mixture. The starting materials used comprise benzoic esters whose alkyl radicals bonded to the O atom of the ester group contain from 1 to 8 carbon atoms. These radicals may be aliphatic, straight-chain or branched, alicyclic, or aromatic. One or more methylene groups in these alkyl radicals may be substituted by oxygen. It is advantageous that the alcohols on which the starting ester is based have lower boiling points than the isononanol mixture or nonanol used. Preferred starting materials for the transesterification are methyl benzoate, ethyl benzoate, propyl benzoate, isobutyl benzoate, n-butyl benzoate and/or pentyl benzoate.

The transesterification is carried out catalytically, for example using Brönstedt or Lewis acids, or using bases. Quite irrespective of the catalyst used, the result is always a temperature-dependent equilibrium between the starting material (alkyl benzoate and isononanol mixture or nonanol) and the products (nonyl ester or nonyl ester mixture and liberated alcohol). In order to shift the equilibrium in favor of the nonyl ester or of the isononyl ester mixture, the alcohol produced from the starting ester is distilled off from the reaction mixture.

Here, too, it is advantageous to use excess of the isononanol mixture or, respectively, nonanol.

Transesterification catalysts which may be used are acids, such as sulfuric acid, methanesulfonic acid, or p-toluene sulfonic acid, or metals or their compounds. Examples of those suitable are tin, titanium, and zirconium, these being used in the form of finely divided metals, or advantageously in the form of their salts, oxides, or soluble organic compounds. Unlike protonic acids, the metal catalysts are high-temperature catalysts whose full activity is often not achieved until temperatures reach above 180° C. However, their use is preferred since the level of formation of by-products, such as olefins from the alcohol used, is lower when comparison is made with protonic catalysis. Examples representing metal catalysts are tin powder, stannous oxide, stannous oxalate, titanium esters, such as tetraisopropyl orthotitanate or tetrabutyl orthotitanate, and zirconium esters, such as tetrabutyl zirconate.

Use may also be made of basic catalysts, such as oxides, hydroxides, hydrogen carbonates, carbonates, or alkoxides of alkali metals or of alkaline earth metals. Among this group, preference is given to using alkoxides, such as sodium methoxide. It is also possible to prepare alkoxides in situ from an alkali metal and an isonanol mixture or, respectively, a nonanol.

The concentration of catalyst depends on the nature of the catalyst. It is usually from 0.005 to 1.0% by weight, based on the reaction mixture.

The reaction temperatures for transesterification are usually from 100 to 220° C. They have to be at least high enough to permit the alcohol produced from the starting ester to be distilled off from the reaction mixture at the prevailing pressure, mostly atmospheric pressure.

The work-up of the transesterification mixtures may be the same as described for the esterification mixtures.

There are various methods for preparing the compositions of the invention. The compositions are generally prepared by intimate mixing of all of the components in a suitable mixing container. In this process, the components are preferably added in succession (e.g. E. J. Wickson, “Handbook of PVC Formulating”, John Wiley and Sons, 1993, p. 727, incorporated herein by reference).

The compositions of the invention may be used to produce foamed products which comprise at least one polymer selected from polyvinyl chloride, polyvinylidene chloride, chlorinated polyolefins and copolymers of vinyl chloride with vinylidene chloride, vinyl acetate, vinyl propionate, vinyl butyrate, vinyl benzoate, methyl acrylate, ethyl acrylate, butyl acrylate, and comprise at least one primary plasticizer, isononyl benzoate, and, where appropriate, other additives. By way of example, these products may be synthetic leather, wallcoverings, or the various foam layers for floorcoverings (cushion vinyl foam or foam backing).

The compositions of the invention are preferably used to prepare plastisols, in particular to prepare PVC plastisols, with particularly advantageous processing properties. These foamable plastisols may be used in a wide variety of products, such as synthetic leather, floorcoverings, wallcoverings, etc. Among these applications, particular preference is given to the use in cushion vinyl (CV) floorcoverings. Use of the compositions of the invention as a mixing specification constituent or directly in the form of plastisols can give plastisols with low viscosity and with increased storage stability, and at the same time with faster gelling and improved low-temperature flexibilization.

The process of the invention for producing products which have a foamed polymer layer selected from the following polymers: polyvinyl chloride, polyvinylidene chloride, chlorinated polyolefins and copolymers of vinyl chloride with vinylidene chloride, vinyl acetate, vinyl propionate, vinyl butyrate, vinyl benzoate, methyl acrylate ethyl acrylate, butyl acrylate, includes applying a composition of the invention to a backing or a further polymeric layer and foaming prior to or after application, and finally heating to process the composition.

The foaming may take place mechanically or chemically. The expression mechanical foaming of a composition or a plastisol means that sufficiently vigorous agitation is used to introduce air into the plastisol prior to application to the backing, and that the entrained air results in foaming. A stabilizer may be needed to stabilize the resultant foam. Use is generally made of systems based either on silicone or on soaps. These differ in respect of the finished foam, primarily in cell structure, color, and water absorption performance. The selection of the stabilizer type depends inter alia on the plasticizers intended for use. For example, it is known to the person skilled in the art that when use is made of the relatively low-price foam stabilizers based on soaps it is necessary to add sufficiently large amounts of benzyl phthalate (e.g. BBP) or of glycol dibenzoates to the dialkyl phthalates usually used, for example DEHP, DINP, DIDP, or DIHP. Because the use of BBP is reducing markedly in recent times as a result of its imminent classification in chemicals legislation (“toxic”), glycol dibenzoates are often used as replacement materials. The term glycol dibenzoates includes diethylene glycol dibenzoate (DEGDB), triethylene glycol dibenzoate (TEGDB) and dipropylene glycol dibenzoate (DPGDB), or a mixture of these. These products are commercially available by way of example with the tradename “Benzoflex” from Velsicol, USA. Benzoflex 2088 (according to manufacturer's information from 61 to 69% of DEGDB, from 16 to 24% of DPGDB, from 11 to 19% of TPGDB) and Benzoflex 2160 (according to the manufacturer's information 49% of DEGDB, 29% of TEGDB, 15% of di-2-ethylhexyl adipate, inter alia) have achieved some significance as blends of glycol dibenzoates in the PVC floorcovering sector. However, these products have a strong dilatent tendency, i.e. tend to give a marked rise in viscosity at relatively high shear rates, a possible result being problems during processing. Blends of these glycol dibenzoates with isononyl benzoate can very substantially compensate for this disadvantage. Foamable compositions of the invention intended for use for producing mechanical foams may therefore comprise glycol dibenzoates alongside isononyl benzoate. The foamed composition is then applied to the backing or to another polymer layer, and is finally treated with heat. Examples of commercially available foam stabilizers based on soaps include BYK 8070 (Byk-Chemie) and SYNTHAMID 218 (Th. Boehme GmbH). BYK 8020 (Byk-Chemie) is a widely used silicone-based system.

In the case of chemical foaming, the plastisol or the composition of the invention comprises a compound known as a blowing agent which, when exposed to heat, decomposes to give predominantly gaseous constituents which bring about expansion of the plastisol. One typical representative is azodicarbonamide. The decomposition temperature of the blowing agent may be markedly reduced by adding catalysts. These catalysts are familiar as “kickers” to the person skilled in the art, and may be added either separately or preferably in the form of a single system with the heat stabilizer. Unlike in the case of the mechanical foam, it is possible, where appropriate, to omit a foam stabilizer. Unlike in mechanical foaming, in chemical foaming the foam is not formed until processing begins, generally in a gelling tunnel, and this means that the as yet unfoamed composition is applied to the backing, preferably by spreading. In this embodiment of the process of the invention, it is possible to profile the foam by selective application of inhibitor solutions, for example by way of a rotary screen printing system. At the sites where the inhibitor solution has been applied, no expansion, or only retarded expansion, of the plastisol takes place during processing. Industry uses chemical foaming to a much greater extent than mechanical foaming. Further information concerning chemical and mechanical foaming may be found by way of example in E. J. Wickson, “Handbook of PVC Formulating”, 1993, John Wiley & Sons (incorporated herein by reference in its entirety).

In the case of both processes, the backing materials used may comprise those which remain firmly bonded to the resultant foam, e.g. woven or nonwoven webs. However, the backing materials may also be merely temporarily backing materials, from which the resultant foams can in turn be removed in the form of foam layers. Examples of these backing materials may be metal belts or release paper (Duplex paper). Another polymer layer, where appropriate one which has previously been completely or partially gelled (e.g., pre-gelled), may also function as a backing. This method is used in particular for CV floorcoverings whose structure is composed of a plurality of layers.

In both cases, the final treatment with heat takes place in what is known as a gelling tunnel, generally an oven, through which a layer applied to the backing and composed of or containing the composition of the invention is passed, or into which the backing with the layer is introduced for a short period. The final treatment with heat serves to solidify (gel) the foamed layer. In the case of chemical foaming, the gelling tunnel may be combined with an apparatus serving to produce the foam. For example, it is possible to use only one gelling tunnel, in the upstream portion of which, at a first temperature, the foam is produced chemically by decomposition of a gas-forming component, this foam being converted in the downstream portion of the gelling tunnel, at a second temperature which is preferably higher than the first temperature, into the semifinished or finished product. Depending on the composition, it is also possible for gelling and foam-formation to take place simultaneously at a single temperature. Typically processing temperatures (gelling temperatures) are in the range from 130 to 280° C., preferably in the range from 150 to 250° C. In the preferred manner of gelling, the foamed composition is treated at the gelling temperatures mentioned for a period of from 0.5 to 5 minutes, preferably for a period of from 0.5 to 3 minutes. In the case of processes which operate continuously, the duration of the heat treatment here may be adjusted via the length of the gelling tunnel and the velocity with which the backing, on which the foam is applied, passes through the same. Typical foam-formation temperatures (chemical foam) are in the range from 160 to 240° C., preferably from 180 to 220° C.

In the case of multilayer systems, the shape of the individual layers is generally first fixed by what is known as pre-gelling of the applied plastisol at a temperature below the decomposition temperature of the blowing agent, and after this other layers (e.g. a top layer) may be applied. Once all of the layers have been applied, a higher temperature is used for the gelling processes—and also for the foam-forming process in the case of chemical foaming. The desired profiling can also be extended to the top layer by this procedure.

By way of the compositions of the invention, and of the process of the invention, it is possible to produce products which comprise at least one polymer selected from polyvinyl chloride, polyvinylidene chloride, chlorinated polyolefins and copolymers of vinyl chloride with vinylidene chloride, vinyl acetate, vinyl propionate, vinyl butyrate, vinyl benzoate, methyl acrylate, ethyl acrylate, butyl acrylate, and which comprise foamed layers of a composition of the invention. Examples of these products may be floorcoverings, wallcoverings, or synthetic leather.

The examples below are intended to illustrate the invention without restricting the breadth of application that is apparent from the description and from the claims.

### EXAMPLE 1

Preparation of Isononyl Benzoate

976 g of benzoic acid (8 mol), 1728 g of isononanol from OXENO Olefinchemie GmbH (12 mol), and 0.59 g of butyl titanate (0.06%, based on the amount of acid) were weighed in a 4 liter distillation flask on which there is a water separator and reflux condenser, and also a sampling stub and thermometer, and were heated to boiling under nitrogen. The water produced during the esterification reaction was removed regularly. When (after about 3 hours) the acid value fell below 0.1 mg KOH/g, the mixture was first cooled below 60° C., and a 20 cm multifill column was superposed. The pressure was then reduced to 2 mbar, and the excess alcohol was then distilled off (about 120° C.). After removal of an intermediate fraction at up to 140° C., the isononyl benzoate could be distilled over in the range from 142 to 147° C. (at 2 mbar), measured at the head of the column. The purity determined by gas chromatography was >99.7%. The viscosity of the product at 20° C. was determined to DIN 53 015 as 8.4 mPa·s.

### EXAMPLE 2

Preparation of Plastisols for Chemical Foam (CV Foam)

The starting weights of the components are given in the table below.

TABLE 1
Mixing specifications (all data in phr (= parts by
weight per 100 parts of PVC))

| | | | | 4 | 5 (Top |
|---|---|---|---|---|---|
| | 1 | 2 | 3 | inventive | Layer) |
| VESTOLIT P1352 | 80 | 80 | 80 | 80 | |
| K (Vestolit) | | | | | |
| VESTOLIT P1430 | | | | | 80 |
| K90 (Vestolit) | | | | | |
| VINNOLIT C65V (Vinnolit) | 20 | 20 | 20 | 20 | 20 |
| VESTINOL AH (DEHP, | | | | | 35 |
| OXENO) | | | | | |
| VESTINOL 9 (DINP, | 40 | 40 | 40 | 40 | 12 |
| OXENO) | | | | | |
| Unimoll BB (BBP, Bayer) | 17 | | | | |
| Diisobutyl phthalate | | 17 | | | |
| (DIBP, OXENO) | | | | | |
| Benzoflex 2088 (Velsicol) | | | 17 | | |
| Isononyl benzoate (INB) | | | | 17 | |
| Lankroflex ED 6 (Akcros) | | | | | 3 |
| Baerostab CT 9156 | | | | | 1.5 |
| X (Baerlocher) | | | | | |
| Porofor ADC/L-C2 | 4 | 4 | 4 | 4 | |
| (1:1) (Bayer) | | | | | |
| Bayoxid Z Aktiv (1:2) (Bayer) | 1.5 | 1.5 | 1.5 | 1.5 | |
| Kronos 2220 (titanium | 5 | 5 | 5 | 5 | |
| dioxide, Kronos) | | | | | |
| Durcal 5 (chalk, Omya) | 10 | 10 | 10 | 10 | |

The plasticizers were brought to a temperature at 25° C. prior to addition. The liquid constituents were weighed first into a PE beaker and were followed by the pulverulent constituents. The mixture was mixed manually using a paste spatula until all the powder had been wetted. The mixing beaker was then clamped into the clamping equipment of a dissolver mixer. Prior to immersing the stirrer into the mixture, the rotation rate was set at 1 800 revolutions per minute. Once the stirrer had been switched on, stirring was continued until the temperature on the digital display of the temperature sensor reached 30.0° C. This ensured that the plastisol was homogenized with defined energy input. The temperature of the plastisol was then immediately brought to 25.0° C.

### EXAMPLE 3

Testing of Plastisol Viscosities

The viscosities of plastisols 1 to 4 prepared in example 2 were measured as follows by a method based on DIN 53 019, using the Physica DSR 4000 rheometer, controlled by US 200 software.

The plastisol was again stirred with a spatula in the storage vessel, and was tested in accordance with the operating instructions in test system Z3 (DIN 25 mm). Measurement proceeded automatically at 25° C. by way of the abovementioned software. The settings were as follows:
pre-shear of 100 s⁻¹ for a period of 60 s, during which no values were measured,
a downward progression beginning at 200 s⁻¹ and ending at 0.1 s⁻¹, divided into a logarithmic series with 30 steps, the duration for each point of measurement being 5 s.

After the test, the test data were processed automatically by the software. Viscosity was plotted as a function of shear rate. Each of the measurements was made after 2 h and 24 h. Between these junctures, the paste was stored at 25° C.

The two tables below, Table 2 and Table 3, list the viscosity values obtained after each of the storage times given for shear rates of 10 s⁻¹ and 100 S⁻¹.

TABLE 2
Shear rate 10 s⁻¹ (viscosity data in Pa * s)

Mixing specification

| | | | | 4 |
|---|---|---|---|---|
| | 1 | 2 | 3 | (inventive) |
| 2 h | 3.9 | 3.9 | 3.8 | 2.7 |
| 24 h | 5.2 | 5.0 | 4.8 | 3.1 |

TABLE 3
Shear rate 100 s⁻¹ (viscosity data in Pa * s)

Mixing specification

| | | | | 4 |
|---|---|---|---|---|
| | 1 | 2 | 3 | (inventive) |
| 2 h | 4.3 | 3.9 | 4.5 | 2.1 |
| 24 h | 5.7 | 5.2 | 5.7 | 2.6 |

On the basis of the measured values listed in Tables 2 and 3 it can be shown that the foam plastisols using isononyl benzoate (mixing specification 4) differ substantially in their viscosity behavior from the plastisols with identical proportions of BBP, DIBP, or Benzoflex 2088. Because the viscosity of the plastisol of the invention is lower, it is possible to omit, or at least reduce the amount of, viscosity-lowering reagents, which are frequently expensive.

### EXAMPLE 4

Chemical Foaming at 200° C.

A doctor is used to apply plastisols 1 to 4 prepared in example 2 onto Kamplex LWB duplex paper (120 g/m², Kämmerer), to give an application rate of 360±10 g/m². For drying/pre-gelling, this material is passed at 6 m/min through a gelling tunnel (Olbrich, length 8 m) at a temperature of 130° C. A similar procedure is then used in each case to apply in top layer (mixing specification 5 from Table 1, application rate 200+10 g/m²) to this layer. The gelling/foaming process is then carried out at 200° C. with various residence times, set by way of the conveying speed of the system. The thickness of each of the foamed layers was measured.

The thicknesses of the resultant products can be used to determine the foaming ratio in percent, based on the thickness of the product which has been pregelled but not further processed. Table 4 gives the foaming ratios for mixing specifications 1 to 4 after a residence time of 60, 80, 100, and 120 seconds.

TABLE 4
Foaming ratios for mixing specifications 1 to 4 (data in percent)

Residence time (s)

| | 60 | 80 | 100 | 120 |
|---|---|---|---|---|
| Mixing specification 1 | 1.7 | 94.9 | 245.8 | 289.8 |
| Mixing specification 2 | 0.0 | 77.6 | 237.9 | 291.4 |
| Mixing specification 3 | 0.0 | 91.5 | 239.0 | 274.6 |
| Mixing specification 4 | 0.0 | 62.1 | 246.6 | 317.2 |
| (inventive) | | | | |

Despite somewhat slower foaming of plastisol 4 of the invention at a relatively low residence time of 80 s (in the middle of the foaming process) it is apparent that at typical industrial residence times of 100 s or above the comparable foaming ratios that can be obtained are at least the same or indeed better.

### EXAMPLE 5

Mechanical Foaming (Preparation of Plastisols)

The following plastisols were prepared using the overall mixing specification given in Table 5 below:

TABLE 5
Mixing specifications for plastisols for
mechanical foaming (data in phr)

| | 6 | 7 | 8 | 9 |
|---|---|---|---|---|
| VESTOLIT P1415K80 (Vestolit) | 70 | 70 | 70 | 70 |
| VINNOLIT C65V (Vinnolit) | 30 | 30 | 30 | 30 |
| VESTINOL 9 (OXENO) | 30 | 30 | 30 | 30 |
| Unimoll BB (BBP, Bayer) | 30 | | | |
| Benzoflex 2088 (Velsicol) | | 30 | 20 | 15 |
| Isononyl benzoate | | | 10 | 15 |
| Byk 8070 (Byk-Chemie) | 2.6 | 2.6 | 2.6 | 2.6 |
| Durcal 5 (chalk, Omya) | 30 | 30 | 30 | 30 |

Once the plastisols have been prepared as in Example 2, these are de-aerated at 20 mbar in order to remove any air introduced by the mixing process. The de-aeration procedure is simpler in all instances for the low-viscosity plastisols than for those of higher viscosity.

As in Example 3, a Physica rheometer was likewise used to determine the viscosities of plastisols 6 to 9 after 2 and 24 hours at shear rates of 10 and 100 s⁻¹, and these have been listed in Tables 6 and 7.

TABLE 6
Viscosities of plastisols at shear rate 10 s⁻¹ in Pa * s:

| | 6 | 7 | 8 | 9 |
|---|---|---|---|---|
| After 2 h | 3.2 | 3.5 | 2.0 | 1.5 |
| After 24 h | 3.6 | 3.9 | 2.2 | 1.6 |

TABLE 7
Viscosities of plastisols at shear rate of 100 s⁻¹ in Pa * s:

| | 6 | 7 | 8 | 9 |
|---|---|---|---|---|
| After 2 h | 3.9 | 4.8 | 2.5 | 1.9 |
| After 24 h | 4.4 | 5.4 | 2.8 | 2.0 |

Here again, the effect of rising content of isononyl benzoate on the viscosity of the plastisols is discernible.

The behavior of the plastisol under conditions close to production conditions is again tested in a gelling tunnel (Olbrich, length 8 m). After pre-foaming by introducing air through nozzles, with stirring, to give a wet foam density of 0.61 g/cm³, a doctor (gap width 1.5 mm; doctor chamfer 9 mm, doctor angle 7°) is used to apply the plastisol to Kamplex LWB duplex paper (120 g/m², Kämmerer), and it is then run at a pre-set speed through the gelling tunnel.

If the residence time in the gelling tunnel is varied at a processing temperature of 180° C., it is possible to determine the maximum processing or spreading speed which still gives a stable foam. The homogeneity of the surface is decisive for this assessment, and is evaluated visually. In addition, the foam densities in the fully gelled final product were determined by weighing and thickness measurement, using the residence time of 1.3 min which is typical for industrial purposes (corresponding here to a speed of 6 m/min). The results are given in Table 8.

TABLE 8
Results of processing

| | 6 | 7 | 8 | 9 |
|---|---|---|---|---|
| Max. spreading speed in | 8 | 10 | 10 | 8 |
| m/min. | | | | |
| Foam density in g/cm³ | 0.60 | 0.65 | 0.58 | 0.56 |
| after 1.3 min. of | | | | |
| residence time (typical) | | | | |

As can be seen from the results in Table 8, the plastisols of the invention using isononyl benzoate (mixing specification 8 or 9) can be foamed to a greater extent at maximum spreading speeds comparable with those for mixing specifications 6 and 7, this being discernible from the lower density.

German application 10336150.2 filed on Aug. 7, 2003 is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

1. A foamable composition comprising at least one chlorinated polymer, at least one alkyl benzoate, and at least one primary plasticizer;
wherein isononyl benzoate is present in an amount of from 5 to 95% by weight based on the total weight of the primary plasticizers and the alkyl benzoates, and wherein the total weight of the primary plasticizers and the alkyl benzoates is from 10 to 400 parts by weight based on 100 parts by weight of the chlorinated polymers.

2. The composition as claimed in claim 1, wherein the chlorinated polymer is at least one selected from the group consisting of polyvinyl chloride, polyvinylidene chloride, chlorinated polyolefin, vinyl chloride-vinylidene chloride copolymer, vinyl acetate-vinyl chloride copolymer, vinyl propionate-vinyl chloride copolymer, vinyl butyrate-vinyl chloride copolymer, vinyl benzoate-vinyl chloride copolymer, methyl acrylate-vinyl chloride copolymer, ethyl acrylate-vinyl chloride copolymer, and butyl acrylate-vinyl chloride copolymer.

3. The composition as claimed in claim 1, comprising one or more of an alkyl phthalate, an alkyl cyclohexanedicarboxylate, or an alkyl adipate.

4. The composition as claimed in claim 1, comprising at least one alkyl phthalate selected from the group consisting of diisononyl phthalate, diisoheptyl phthalate, and di-2-ethylhexyl phthalate.

5. The composition as claimed in claim 1, comprising diisononyl cyclohexanedicarboxylate.

6. The composition as claimed in claim 1, comprising diisononyl adipate.

7. The composition as claimed in claim 1, comprising at least one selected from the group consisting of diisononyl phthalate, diisoheptyl phthalate and di-2-ethylhexyl phthalate; diisononyl cyclohexanedicarboxylate; and diisononyl adipate.

8. The composition as claimed in claim 1, further comprising at least one additive selected from the group consisting of a filler, a pigment, a heat stabilizer, an antioxidant, a viscosity regulator, a foam stabilizer, and a lubricant.

9. The composition as claimed in claim 1, further comprising a component which generates gas bubbles.

10. The composition as claimed in claim 9, further comprising a kicker.

11. The composition as claimed in claim 1, comprising an emulsion PVC.

12. The composition as claimed in claim 1, comprising PVC and diisobutyl phthalate.

13. The composition as claimed in claim 12, further comprising one or more of a filler, titanium dioxide or a release agent.

14. The composition of claim 11, further comprising at least one glycol dibenzoate.

15. The composition of claim 11, further comprising at least one alkyl benzyl phthalate.

16. A product comprising a foamed layer obtained by foaming the composition of claim 1.

17. The product as claimed in claim 16, which is a floor covering, a wall covering, or a synthetic leather.

18. A process for producing a product having a foamed chlorinated polymer layer comprising at least one chlorinated polymer, at least one primary plasticizer and at least one alkyl benzoate; wherein isononyl benzoate is present in the foamed chlorinated polymer layer in an amount of from 5 to 95% by weight based on the total weight of the primary plasticizers and the alkyl benzoates, and the total weight of the primary plasticizers and the alkyl benzoates is from 10 to 400 parts by weight based on 100 parts by weight of the chlorinated polymers, said process comprising
applying the composition as claimed in claim 1 to a backing,
foaming the composition prior to or after application, and then
heating the applied and foamed composition.

19. The process as claimed in claim 18, wherein the chlorinated polymer layer is at least one selected from the group consisting of polyvinyl chloride, polyvinylidene chloride, chlorinated polyolefin, vinyl chloride-vinylidene chloride copolymer, vinyl acetate-vinyl chloride copolymer, vinyl propionate-vinyl chloride copolymer, vinyl butyrate-vinyl chloride copolymer, vinyl benzoate-vinyl chloride copolymer, methyl acrylate-vinyl chloride copolymer, ethyl acrylate-vinyl chloride copolymer, and butyl acrylate-vinyl chloride copolymer

20. A foamed product obtained by the process as claimed in claim 19.
